(19) United States
(12) Patent Application Publication
(10) Pub. No.: US 2005/0198933 A1
(43) Pub. Date: Sep. 15, 2005

(54) Deck for mowers

(76) Inventors: John A. Klein, Seguin, TX (US); Billy S. Steele, Seguin, TX (US)

Correspondence Address: GUNN, LEE & HANOR, 700 N. ST. MARY'S STREET, SUITE 1500, SAN ANTONIO, TX, 78205, US

(21) Appl. No.: 10/800,825

(22) Filed: Mar. 15, 2004

(51) Int. Cl. A01D 67/00

(52) U.S. Cl. 56/320.1

(57) ABSTRACT

A deck for mowers including an upper and lower decks with structured frame members in between. Both upper and lower decks attach to front and rear cross members at substantially the same point. Upper deck at sides slopes down and is formed with smooth radius; lower deck attaches to bottom side of upper deck just inside of smooth radius. The upper deck is crowned or elevated so that it slopes downward in all directions—front, rear, and sides. The top deck is shaped so that debris and water will divert or fall off the deck.

### BACKGROUND OF THE INVENTION

1. Field of the Invention

Applicant's invention relates to a deck for mowers, more particularly to a deck for rotary mowers.

2. Background Information

Rotary mowers are known in the art for cutting and shredding material by towing the cutter deck across the desired terrain. The cutter deck itself houses one or more mounted rotary blades that spin upon actuation by a power source. The construction of the cutter deck should be such that it protects the user from injury that can occur from the moving blades or from objects or debris being projected from the underside of the cutter deck when the blades are in operation. In this construction, the cutter deck should have a solid framework to provide extraordinary protection for the user. The present invention was designed with the safety of the user in mind incorporating a solid infrastructure which is herein further defined covered by a lower deck and upper deck.

### SUMMARY OF THE INVENTION

It is an object of the present invention to provide a novel deck for mowers.

Still another object of the present invention is to provide a novel deck for mowers having a front cross member and rear cross member connected to a left and right skirt.

Yet an additional object of the present invention is to provide a novel deck for mowers that incorporates a solid infrastructure covered by lower deck and upper deck.

It is another object of the present invention to provide a novel deck for mowers having a central cross channel connected across left and right channel members with the left and right channel members extending from the front cross member to rear cross member.

An additional object of the present invention is to provide a novel deck for mowers that has an upper deck connected at its sides to a lip.

In satisfaction of these and related objectives, Applicant's present invention provides for a deck for mowers. The present invention has a front cross member positioned parallel to a rear cross member. Rear cross member has a top section and a bottom section. One end of front cross member sits atop a left skirt while the remaining end sits atop a right skirt. Left skirt has an inward arch beginning near mid section of left skirt and extends to the left end of rear cross member while the right skirt has an inward arch beginning near mid section of right skirt and extends to the right end of rear cross member.

Left skid shoe is positioned at the bottom edge of the left skirt and extends from approximately the mid section of left skirt to the front of the left skirt. Right skid shoe borders the bottom edge of the right skirt and extends from approximately the mid section right skirt to the front of right skirt.

The remaining infrastructure of the present invention includes left and right channel members. Situated above left and right channel members are left and right hitch assemblies. These hitch assemblies have inside limbs and outside limbs. Both inside limbs and outside limbs extend up from channel members at an angle and are connected at their opposite end by links.

Centrally located across the left and right channel members is the center cross channel that contains flanges with gear box shaft centered bores surrounded by gear box mounting holes which are designed to support a transversely spaced rotary cutter. Situated under the left and right channel members and center cross channel is the lower deck. The lower deck is covered by the upper deck to form the final structure of the present invention. The upper and lower deck have structured frame members in between for torsional stiffness.

### BRIEF DESCRIPTION OF THE DRAWINGS

FIG. 1 is a perspective view of the preferred embodiment of the present invention.

FIG. 2 is a side view of the preferred embodiment of the present invention.

FIG. 3 is a bottom view of the preferred embodiment of the present invention.

FIG. 4 is a perspective view of the preferred embodiment of the present invention with upper deck removed.

FIG. 5 is a perspective view of the preferred embodiment of the present invention with upper deck and lower deck removed.

### DETAILED DESCRIPTION OF THE PREFERRED EMBODIMENT

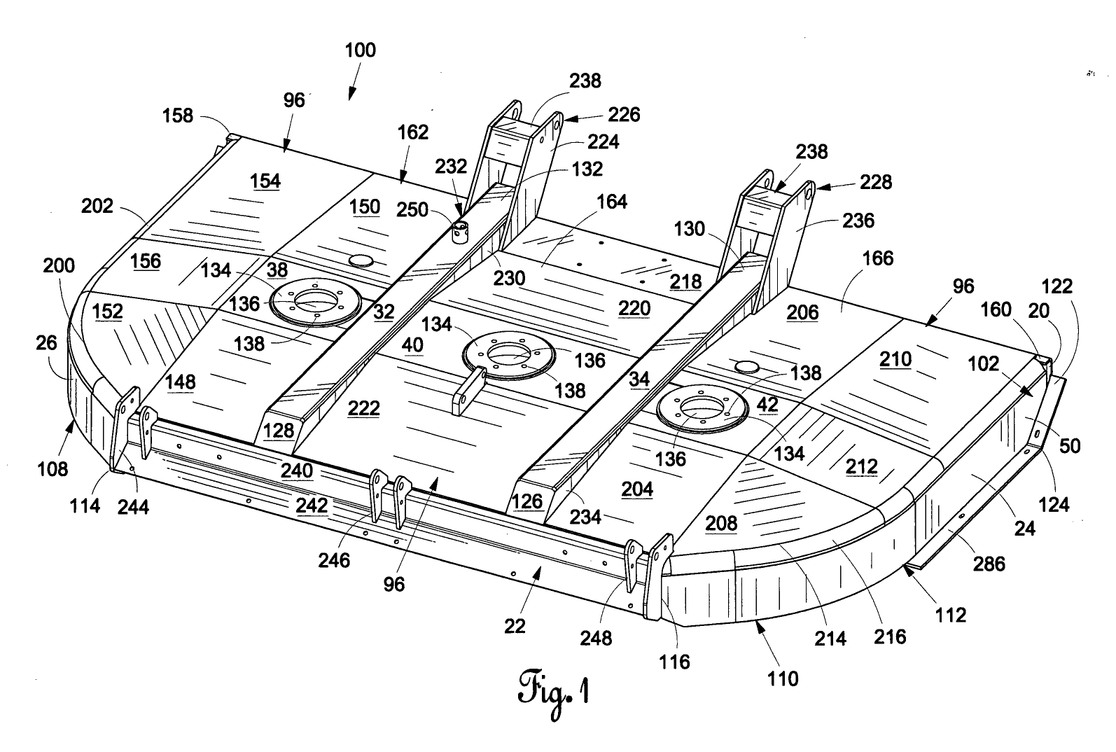

FIG. 1 is a perspective view of the preferred embodiment of the present deck 100 for a rotary cutter (not shown). The deck 100 has a transverse front cross member 20 positioned parallel to the rear cross member 22. Front cross member 20 only becomes a tube when the present deck 100 is welded. Rear cross member 22 is shorter in length than front cross member 20. Front cross member 20 defines the front perimeter of the present deck 100, while the rear cross member 22 defines the rear perimeter.

Rear cross member 22 has a top section 240 and a bottom section 242. The top section 240 is generally flat and bounded at both ends by pieces 244. In the completed invention, pieces 244 look generally inverted L-shaped with the lower portion of the L extending over upper deck 96 at points 116 and 114 and the upper portion of the L extending down along the front of rear cross member 22 to the base of the present deck 100. Centrally located along top section 240 are pieces 246 with pieces 248 located toward the ends of top section 240. Pieces 246 and 248 are generally inverted J-shaped with the lower portion of the J extending over the topmost is portion of rear cross member 22 and the upper portion of the J extending down along the front of rear cross member 22 terminating at bottom section 242. Top section 240 is contiguous with bottom section 242. Bottom section 242 extends from top section 240 at an outward angle toward the base of the present deck 100. Bottom section 242 is generally flat and bounded at both ends by pieces 244 which continue down from top section 240. The lowermost portion of pieces 246 and 248 extends down to bottom section 242.

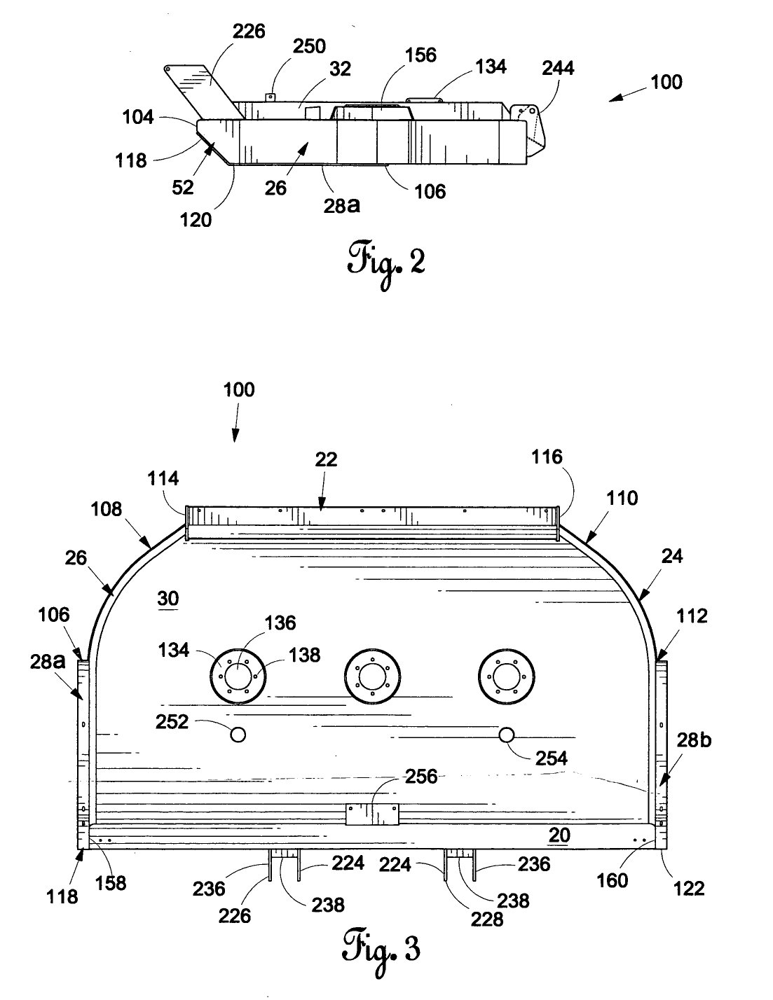

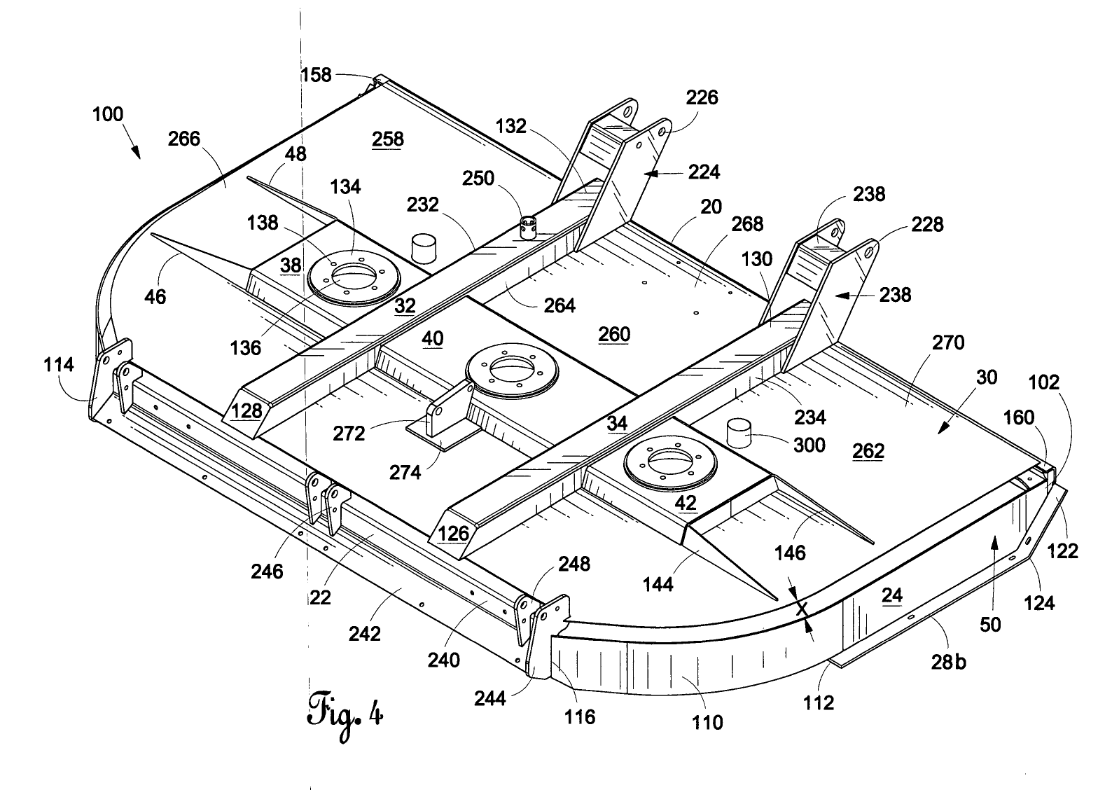

One end 158 of front cross member 20 abuts left skirt 26. Left skirt 26 runs from front to rear of the present deck 100 and contains a substantially triangular section 52 (See FIG. 2) which forms an apex 104 (See FIG. 2) at the upper corner of left skirt 26. Left skirt 26 has an inward arch 108 beginning near mid section of left skirt 26 (See FIG. 3) and the rear end of left skid shoe 28a (See FIG. 3) at point 106 (See FIG. 3) extending to the left end point 114 of rear cross member 22.

Left skid shoe 28a (See FIG. 3) is a single track rail that borders the outer, bottom edge of the left skirt 26 and extends from approximately the mid section of left skirt 26 to the front of the left skirt 26 at point 118 (See FIG. 3). Left skid shoe 28a is generally parallel with the left skirt 26 but at point 120 (See FIG. 2) it angles at a sharp upward incline near the rear of section 52 (See FIG. 2) and terminates near the apex 104 (See FIG. 2) of section 52 (See FIG. 2).

The remaining end 160 of the front cross member 20 abuts right skirt 24. Right skirt 24 runs from front to rear of the present deck 100 and contains a substantially triangular section 50 which forms an apex 102 at the upper corner of right skirt 24. Right skirt 24 has an inward arch 110 beginning near the mid section of right skirt 24 and the rear end of right skid shoe 28b at point 112 and extending to the right end point 116 of rear cross member 22.

Right skid shoe 28b is a single track rail that borders the outer, bottom edge of the right skirt 24 and extends from approximately the mid section of right skirt 24 to the front of right skirt 24 at point 122. Right skid shoe 28b is generally parallel with the right skirt 24 but at point 124 it angles at a sharp upward incline near the rear of section 50 and terminates near the apex 102 of section 50.

Situated at the top of the present deck 100 is an upper deck 96 having a left upper deck 162, a center upper deck 164 and a right upper deck 166. Left and right channel members 32 and 34 are shown toward the center of upper deck 96 with terminating ends 126 and 128 near the rear perimeter of upper deck 96. At the front perimeter of upper deck 96 channel members 32 and 34 have terminating ends 130 and 132. Situated above terminating ends 130 and 132 are left and right hitch assemblies 226 and 228. These hitch assemblies 226 and 228 have inside limbs 224 and outside limbs 236 with inside limbs 224 positioned inside channel members 32 and 34 and outside limbs 236 positioned outside channel members 32 and 34. Both inside limbs 224 and outside limbs 236 extend up from channel members 32 and 34 at an angle and are connected at their opposite end by links 238.

Left upper deck 162 includes sections 148, 150, 152, 154, and 156. Sections 148, 150, 152, 154, and 156 and left section 38 make up a single pre-formed sheet where the front outer perimeter of sections 150 and 154 is attached to front cross member 20 and the rear outer perimeter of section 148 is attached to rear cross tube section 22. Section 150 is substantially square and has a downward incline sloping toward left skirt 26 as well as toward front cross member 20. Section 150 is contiguous with section 154 and bounded by left section 38, outside limb 236 of left hitch assembly 226, and outside portion 232 of left channel member 32. Section 154 is substantially square as well and slopes downward from section 156 toward front cross member 20 and from section 150 toward left skirt 26. Section 154 is contiguous with section 156, which is substantially square. Section 156 forms a downward slope from left section 38 toward left skirt 26. Section 156 is contiguous with left section 38. Section 148 is substantially square and has a downward incline sloping from left section 38 toward rear cross member 22. Section 148 is bounded by left section 38 and outside portion 232 of left channel member 32. Bounded by section 156 and section 148 is section 152. Section 152 is generally triangular with an arch portion 200. The boundaries of sections 152,154 and 156 are separated from left skirt 26 by lip 202. Left section 38 is bounded at each side by sections 148 and 150. This section 38 is generally square and flat bounded at one end by the outside portion 232 of left channel member 32 and at the remaining end by section 156. Left section 38 has a centrally located flange 134 with gear box shaft centered bore 136 surrounded by gear box mounting holes 138 which is designed to support a transversely spaced rotary cutter assembly (not shown).

Center upper deck 164 includes sections 218, 220, and 222 and middle section 40. Section 218 is bounded at one side by front cross member 20 and at the opposing side by section 220. The left and right ends of section 218 are bounded by inside limbs 224 of left and right hitch assemblies 226 and 228. Section 218 is generally rectangular and slopes slightly downward from section 220 toward front cross member 20. Left and right hitch assembly 226 and 228 are supported by left and right channel members 32 and 34 and front cross member.

Section 220 of center upper deck section 164 is bounded on one side by section 218 and at the opposing side by middle section 40. The left and right ends of section 220 are bounded by inside portions 230 of left and right channel members 32 and 34. Section 220 is generally rectangular and slopes downward from middle section 40 toward section 218.

Middle section 40 is bounded at each side by sections 220 and 222. This section 40 is generally rectangular and flat and bounded at each end by inside portions 230 of left and right channel members 32 and 34. Middle section 40 has a centrally located flange 134 with gear box shaft centered bore 136 surrounded by gear box mounting holes 138 which is designed to support a transversely spaced rotary cutter assembly (not shown).

Section 222 is bounded on one side by rear cross member 22 and at the opposing side by middle section 40. The left and right ends of section 220 are bounded by inside portions 230 of left and right channel members 32 and 34. Section 220 is generally rectangular and slopes downward from middle section 40 toward rear cross member 22.

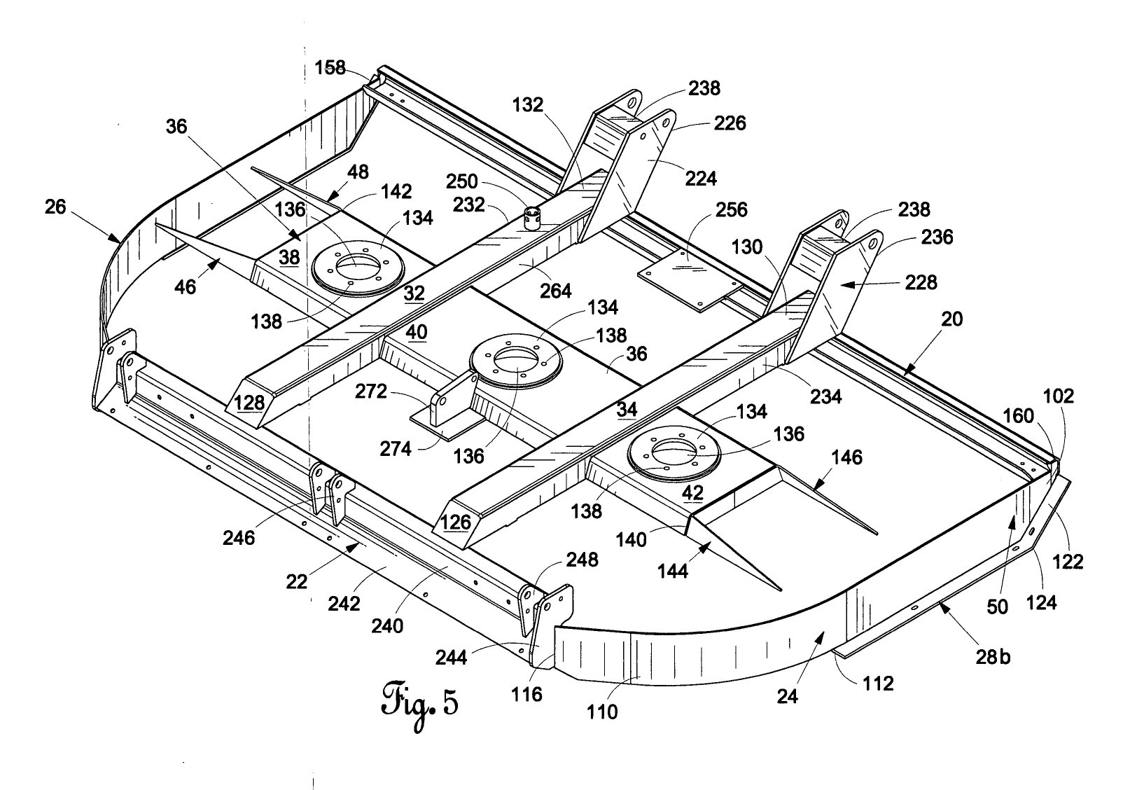

Right upper deck 166 includes sections 204, 206, 208, 210, and 212 and the top of right section 42. These multiple sections are used for torsional stiffness. Sections 204, 206, 208, 210, and 212 make up a single pre-formed sheet where the front outer perimeter of sections 206 and 210 is attached to front cross member 20 and the rear outer perimeter of section 204 is attached to rear cross member 22. Front cross member 20 and rear cross member 22 attach to said upper deck 96 and said lower deck 30 at the front and rear of both said upper deck 96 and said lower deck 30 where said upper deck 96 and said lower deck 30 meet. Section 210 is substantially square and has a downward incline sloping toward right skirt 24 as well as toward front cross member 20. Section 210 is contiguous with section 206. Section 206 is substantially square as well and slopes downward from right section 42 toward front cross member 20. Section 206 is bounded by right section 42, outside portion 234 of right channel member 34, and outside limb 236 of right hitch assembly 228. Section 210 is contiguous with section 212, which is substantially square. Section 212 forms a downward slope from right section 42 toward right skirt 24. Section 204 is substantially square and has a downward incline sloping from right section 42 toward rear cross member 22. Section 204 is bounded by right section 42 and outside portion 234 of right channel member 34. Bounded by section 204 and section 212 is section 208. Section 208 is generally triangular with an arch portion 214. The boundaries of sections 208, 210, and 212 are separated from right skirt 24 by lip 216 having a width X (See FIG. 4). Right section 42 is bounded at each side by sections 204 and 206. This section 42 is generally square and flat and bounded at one side by outside portion 234 of right channel member 34 and at the remaining side by section 212. Right section 42 has a centrally located flange 134 with gear box shaft centered bore 136 surrounded by gear box mounting holes 138 which is designed to support a transversely spaced rotary cutter assembly (not shown).

FIG. 2 is a left side view of the preferred embodiment of the present deck 100. Left skirt 26 is shown which runs from the front to rear of the present invention and contains a substantially triangular section 52 which forms an apex 104 at the upper corner of left skirt 26. Left skid shoe 28a borders the outer, bottom edge of left skirt 26 and extends from approximately the mid section of left skirt 26 at point 106 to the front of the left skirt at point 118, but at point 120 left skid shoe 28a angles at a sharp upward incline near the rear of section 52 and terminates near the apex 104 of section 52. Left channel member 32 is shown as is left hitch assembly 226. Piece 244 is also shown.

FIG. 3 is a bottom view of the preferred embodiment of the present invention. The deck 100 has a transverse front cross member 20 positioned parallel to the rear cross member 22. Flat bracket 256 is shown extending from a central position of front cross member 20. One end 158 of front cross member 20 sits atop a left skirt 26. Left skirt 26 runs from front to rear of the present deck 100. Left skirt 26 has an inward arch 108 beginning near mid section of left skirt 26 and the rear end of left skid shoe 28a at point 106 extending to the left end point 114 of rear cross member 22.

Left skid shoe 28a borders the outer, bottom edge of the left skirt 26 and extends from approximately the mid section of left skirt 26 to the front of the left skirt 26 at point 118. The remaining end 160 of the front cross member 20 sits atop a right skirt 24. Right skirt 24 runs from front to rear of the present deck 100. Right skirt 24 has an inward arch 110 beginning near the mid section of right skirt 24 and the rear end of right skid shoe 28b at point 112 and extending to the right end point 116 of rear cross member 22. Right skid shoe 28b borders the outer, bottom edge of the right skirt 24 and extends from approximately the mid section of right skirt 24 to the front of right skirt 24 at point 122.

Extending from the front of the present deck 100 are left and right hitch assemblies 226 and 228. These hitch assemblies 226 and 228 have inside limbs 224 and outside limbs 236. Links 238 connect inside limbs 224 to outside limbs 236. Flanges 134 with gear box shaft centered bore 136 surrounded by gear box mounting holes 138 are located along the bottom of the present deck 100 and are contiguous with the respective flanges 134 as shown in FIG. 1.

FIG. 4 is a perspective view of the preferred embodiment of the present invention with upper deck 96 removed exposing lower deck 30. The deck 100 has a front cross member 20 positioned parallel to the rear cross member 22. Front cross member 20 is positioned forward and beneath said upper deck 96 and said lower deck 30 defining a front perimeter. Rear cross member 22 has a top section 240 and a bottom section 242. Rear cross member 22 is positioned rearward and beneath said upper deck 96 and said lower deck 30 defining a rear perimeter. The top section 240 is bounded at both ends by pieces 244. In the completed invention, pieces 244 look generally inverted L-shaped with the lower portion of the L extending over lower deck 30 at points 116 and 114 and the upper portion of the L extending down along the front of rear cross member 22 to the base of the present deck 100. Centrally located along top section 240 are pieces 246 with pieces 248 located toward the ends of top section 240. Pieces 246 and 248 are generally inverted J-shaped with the lower portion of the J extending over the topmost portion of rear cross member 22 and the upper portion of the J extending down along the front of rear cross member 22 terminating at bottom section 242. Top section 240 is contiguous with bottom section 242. Bottom section 242 extends from top section 240 at an outward angle toward the base of the present deck 100. Bottom section 242 is generally flat and bounded at both ends by pieces 244 which continue down from top section 240. The lowermost portion of pieces 246 and 248 extends down to bottom section 242.

One end 158 of front cross member 20 abuts left skirt 26 (See FIG. 1). The remaining end 160 of the front cross member 20 abuts right skirt 24. Right skirt 24 runs from front to rear of the present deck 100 and contains a substantially triangular section 50 which forms an apex 102 at the upper corner of right skirt 24. Right skirt 24 has an inward arch 110 beginning near the mid section of right skirt 24 and the rear end of right skid shoe 28b at point 112 and extending to the right end point 116 of rear cross member 22. Left skirt 26 and right skirt 24 are positioned to opposing sides and beneath said upper deck 96 and said lower deck 30.

Right skid shoe 28b extends from approximately the mid section of right skirt 24 to the front of right skirt 24 at point 122. Right skid shoe 28b is generally parallel with the right skirt 24 but at point 124 it angles at a sharp upward incline near the rear of section 50 and terminates near the apex 102 of section 50.

Lower deck 30 is bounded by front cross member 20 and rear cross member 22 and extends short of the inner perimeter of the left and right skirts 26 and 24, respectively. Located on the top side of the lower deck 30 is a transverse, centrally located, oblong box-shaped center cross channel 36. Center cross channel 36 is one continuous piece and has three sections being the left section 338, middle section 340 and right section 342. Lower deck 30 has left deck sheet section 258, middle deck 19 sheet section 260 and right deck sheet section 262. Left deck sheet section 258 incorporates sheet section 266 and left section 338. Left section 338 of center cross channel 36 is positioned over sheet section 266 and against the outside portion 232 of left channel member 32. Left section 338 has a centrally located flange 134 with gear box shaft centered bore 136 surrounded by gear box mounting holes 138 which is designed to support a transversely spaced rotary cutter assembly (not shown).

Middle deck sheet section 260 has sheet section 268 and middle section 340. Middle section 340 is positioned over sheet section 268 between the inside portions 264 of left channel member 32 and right channel member 34. Middle section 340 has a centrally located flange 134 with gear box shaft centered bore 136 surrounded by gear box mounting holes 138. Right deck sheet section 262 incorporates sheet section 270 and right section 342. Right section 342 is positioned over sheet section 270 and against the outside portion 234 of right channel member 34. Right section 342 has a centrally located flange 134 with gear box shaft centered bore 136 surrounded by gear box mounting holes 138. Sheet section 270 incorporates a blade bolt access tube 300. A similar blade bolt access tube is positioned on sheet section 266.

Attached at the end of left section 338 are left gusset plates 46 and 48 with an apex extending toward the center of the deck 100 while attached at the end of right section 342 are right gusset plates 144 and 146 with an apex extending toward the center of the deck 100. Extending toward the rear of middle section 340 is latch 272 with connecting base 274.

Left and right channel members 32 and 34 are shown positioned above and toward the center of lower deck 30 with terminating ends 126 and 128 near the rear perimeter of lower deck 30. At the front perimeter of lower deck 30 channel members 32 and 34 have terminating ends 130 and 132. Situated above terminating ends 130 and 132 are left and right hitch assemblies 226 and 228. These hitch assemblies 226 and 228 have inside limbs 224 and outside limbs 236. Both inside limbs 224 and outside limbs 236 extend up from channel members 32 and 34 at an angle and are connected at their opposite end by links 238. FIG. 5 is a perspective view of the preferred embodiment of the deck 100 with both upper deck 96 (See FIG. 1) and lower deck 30 (See FIG. 4) and center upper deck 164 removed. The deck 100 has a front cross member 20 positioned parallel to the rear cross member 22. Front cross member 20 is generally channeled and incorporates a centrally positioned flat bracket 256. Rear cross member 22 has a top section 240 and a bottom section 242. The top section 240 is bounded at both ends by pieces 244. In the completed invention, pieces 244 look generally inverted L-shaped with the upper portion of the L extending down along the front of rear cross member 22 to the base of the present deck 100. Centrally located along top section 240 are pieces 246 with pieces 248 located toward the ends of top section 240. Pieces 246 and 248 are generally inverted J-shaped with the lower portion of the J extending over the topmost portion of rear cross member 22 and the upper portion of the J extending down along the front of rear cross member 22 terminating at bottom section 242. Top section 240 is contiguous with bottom section 242. Bottom section 242 extends from top section 240 at an outward angle toward the base of the present deck 100. Bottom section 242 is generally flat and bounded at both ends by pieces 244 which continue down from top section 240. The lowermost portion of pieces 246 and 248 extends down to bottom section 242.

One end 158 of front cross member 20 abuts left skirt 26. The remaining end 160 of the front cross member 20 abuts right skirt 24. Left skirt 26 and right skirt 24 run from front to rear of the present deck 100. Right skirt 24 contains a substantially triangular section 50 which forms an apex 102 at the upper corner of right skirt 24. Right skirt 24 has an inward arch 110 beginning near the mid section of right skirt 24 and the rear end of right skid shoe 28b at point 112 and extending to the right end point 116 of rear cross member 22.

Right skid shoe 28b extends from approximately the mid section of right skirt 24 to the front of right skirt 24 at point 122. Right skid shoe 28b is generally parallel with the right skirt 24 but at point 124 it angles at a sharp upward incline near the rear of section 50 and terminates near the apex 102 of section 50.

Located across the center of the present deck 100 is a transverse, centrally located, oblong box-shaped center cross channel 36. Center cross channel 36 is one continuous piece and has three sections being the left section 338, middle section 340 and right section 342. Left section 338 of center cross channel 36 is positioned against the outside portion 232 of left channel member 32. Left section 338 has a centrally located flange 134 with gear box shaft centered bore 136 surrounded by gear box mounting holes 138 which is designed to support a transversely spaced rotary cutter assembly (not shown). Middle section 340 is positioned between the inside portions 264 of left channel member 32 and right channel member 34. Middle section 340 has a centrally located flange 134 with gear box shaft centered bore 136 surrounded by gear box mounting holes 138. Right section 342 is positioned against the outside portion 234 of right channel member 34. Right section 42 has a centrally located flange 134 with gear box shaft centered bore 136 surrounded by gear box mounting holes 138.

Attached at the end of left section 338 are left gusset plates 46 and 48 with an apex extending toward the center of the deck 100 while attached at the end of right section 342 are right gusset plates 144 and 146 with an apex extending toward the center of the deck 100. Extending toward the rear of middle section 340 is latch 272 with connecting base 274.

Left and right channel members 32 and 34 are shown toward the center of the present deck 100 with terminating ends 126 and 128 near the rear perimeter of the present deck 100. At the front perimeter of the present deck 100 channel members 32 and 34 have terminating ends 130 and 132. Situated above terminating ends 130 and 132 are left and right hitch assemblies 226 and 228. These hitch assemblies 226 and 228 have inside limbs 224 and outside limbs 236. Both inside limbs 224 and outside limbs 236 extend up from channel members 32 and 34 at an angle and are connected at their opposite end by links 238.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A deck for mowers comprising:
an upper deck having a raised central portion and sloping downward in all directions;
a right end and a left end of said upper deck positioned downward in a smooth radius whereby a left skirt and a right skirt can be attached to said left end and said right end respectively;
a lower deck positioned under said upper deck and joined to said upper deck at the outer perimeter of said upper deck;
a frame member positioned between said upper deck and said lower deck in a central position whereby multiple sections are created for torsional stiffness; and
front and rear cross members attached to said upper deck and said lower deck at the front and rear of both said upper deck and said lower deck where said upper deck and said lower deck meet.

2. The deck for mowers of claim 1 wherein said rear cross member has centrally located J-shaped pieces.

3. The deck for mowers of claim 1 wherein said front cross member is bounded by said left skirt and said right skirt.

4. The deck for mowers of claim 1 wherein said left skirt and said right skirt further comprise an apex at an upper corner of said skirts.

5. The deck for mowers of claim 4 wherein said left skirt and said right skirt each comprise a skid shoe that borders the outer bottom edge of said skirts and extends from the midsection of said skirts to the front of said skirts at said apex.

6. The deck for mowers of claim 1 further comprising a hitch assembly supported by left and right channel members and said front cross member.

7. The deck for mowers of claim 6 wherein said hitch assembly is positioned perpendicular to said front cross member.

8. A deck for mowers comprising:
an upper deck;
a lower deck positioned below said upper deck;
a front cross member positioned forward and beneath said upper deck and said lower deck defining a front perimeter;
a rear cross member positioned rearward and beneath said upper deck and said lower deck defining a rear perimeter;
a left skirt and a right skirt positioned to opposing sides and beneath said upper deck and said lower deck;
wherein said upper deck comprises:
a horizontal segment positioned centrally on said upper deck with its length parallel to said rear cross member and having a front and rear side;
a first sloping section sloping downward from said rear side of said horizontal segment to said rear cross member;
a second sloping section sloping downward from said front side of said horizontal segment to said front cross member;
a first sloping end sloping downward from a first end of said horizontal segment to a first lip positioned adjacent said left skirt;
a second sloping end sloping downward from a second end of said horizontal segment to a second lip positioned adjacent said right skirt;
at least two sloping diagonal sections sloping diagonally from said horizontal segment to said first lip; and
at least two sloping diagonal sections sloping diagonally from said horizontal segment to said second lip.

9. A deck for mowers comprising:
an upper section;
a central section positioned adjacent said upper section;
a lower section positioned below said upper section;
a front cross member positioned forward and beneath said upper section and said lower section defining a front perimeter;
a rear cross member positioned rearward and beneath said upper section and said lower section defining a rear perimeter;
a first skirt and a second skirt positioned to opposing sides and beneath said upper section and said lower section;
wherein said central section comprises:
a horizontal segment positioned centrally with its length parallel to said rear cross member and having a front and rear side;
a first sloping end sloping downward from a first end of said horizontal segment to a first lip positioned adjacent said first skirt;
a second sloping end sloping downward from a second end of said horizontal segment to a second lip positioned adjacent said second skirt; and
wherein said upper section comprises:
a first sloping section sloping downward from said rear side of said horizontal segment to said rear cross member;
a second sloping section sloping downward from said front side of said horizontal segment to said front cross member;
at least two sloping diagonal sections sloping diagonally from said horizontal segment to said first lip; and
at least two sloping diagonal sections sloping diagonally from said horizontal segment to said second lip.
